(19) United States
(12) Patent Application Publication
(10) Pub. No.: US 2025/0028039 A1
(43) Pub. Date: Jan. 23, 2025

(54) CARRIER-PHASE REPORTING IN WIFI RANGING

(71) Applicant: Samsung Electronics Co., Ltd., Suwon-si (KR)

(72) Inventors: Vishnu Vardhan Ratnam, Plano, TX (US); Bilal Sadiq, Plano, TX (US); Hao Chen, Allen, TX (US); Boon Loong Ng, Plano, TX (US); Jianzhong Zhang, Dallas, TX (US)

(21) Appl. No.: 18/421,737

(22) Filed: Jan. 24, 2024

Related U.S. Application Data
(60) Provisional application No. 63/527,537, filed on Jul. 18, 2023.

(51) Int. Cl. G01S 13/76

(52) U.S. Cl. CPC G01S 13/765

(57) ABSTRACT

Methods and apparatuses for carrier-phase reporting in WiFi ranging. A method of wireless communication performed by an initiating station (ISTA) comprises: providing one or more mechanisms to report carrier-phase information during a fine timing measurement (FTM) protocol between the ISTA and a responding station (RSTA); enabling, via the carrier-phase information, carrier-phase-based relative ranging; and utilizing the carrier-phase information to modify an accuracy for FTM ranging.

### CROSS-REFERENCE TO RELATED APPLICATION(S) AND CLAIM OF PRIORITY

This application claims priority under 35 U.S.C. § 119 (e) to U.S. Provisional Patent Application No. 63/527,537 filed on Jul. 18, 2023, which is hereby incorporated by reference in its entirety.

### TECHNICAL FIELD

This disclosure relates generally to ranging in wireless communications systems, and more particularly to methods and apparatuses for carrier-phase reporting in WiFi ranging.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Indoor positioning has grown in popularity over the last decade in parallel with the growth in the number of personal wireless devices as well as wireless infrastructure. While the use cases are plentiful and include smart homes and buildings, surveillance, disaster management, industry and healthcare, they all require wide availability and good accuracy. A key step of most positioning/localization solutions is ranging which involves identification of the distance (or a difference in distances) of the target device from a set of anchor devices whose locations are known. Correspondingly there can be some ranging techniques in Ultra-wide band (UWB), Lidar and WiFi. WiFi standards groups like 802.11mc and 802.11az have been specifically tailored for enabling accurate WiFi-based ranging via the Fine Timing Measurement (FTM) protocol. Some FTM methods can include: EDCA-based ranging. Trigger-based (TB) ranging, non-TB ranging, and Passive TB ranging.

### SUMMARY

Embodiments of the present disclosure provide methods and apparatuses for carrier-phase reporting in WiFi ranging.

In one embodiment, a method of wireless communication performed by an initiating station (ISTA) is provided, including the steps of: providing one or more mechanisms to report carrier-phase information during a fine timing measurement (FTM) protocol between the ISTA and a responding station (RSTA); enabling, via the carrier-phase information, carrier-phase-based relative ranging; and utilizing the carrier-phase information to modify an accuracy for FTM ranging.

In another embodiment, an ISTA is provided, comprising a processor and a transceiver operably coupled to the processor. The processor is configured to: provide one or more mechanisms to report carrier-phase information during a fine timing measurement (FTM) protocol between the ISTA and a responding station (RSTA); enable, via the carrier-phase information, carrier-phase-based relative ranging; and utilize the carrier-phase information to modify an accuracy for FTM ranging.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of the frame exchange during the measurement phase of enhanced distribution channel access (EDCA) ranging according to various embodiments of the present disclosure;

FIG. 4 illustrates an example of the frame exchange during the measurement phase of trigger-based (TB) ranging according to various embodiments of the present disclosure;

FIG. 5 illustrates an example of the frame exchange during the measurement phase of non-TB ranging according to various embodiments of the present disclosure;

FIG. 6 illustrates an example of the frame exchange during the measurement phase of passive TB ranging according to various embodiments of the present disclosure;

FIG. 7 illustrates an example of a frame structure in the IEEE 802.11a standard according to various embodiments of the present disclosure;

FIG. 8 illustrates the capability indication for supporting carrier phase measurement and reporting in FTM protocol according to various embodiments of the present disclosure;

FIG. 9A illustrates a CPM request field in the FTM parameters element according to various embodiments of the present disclosure;

FIG. 9B illustrates a CPM request field in the ranging parameters element according to various embodiments of the present disclosure;

FIG. 9C illustrates a CPM enabled field in the RSTA availability window element for passive TB ranging according to various embodiments of the present disclosure;

FIG. 10A illustrates CPM reporting in EDCA ranging using the FTM frame according to various embodiments of the present disclosure;

FIG. 10B illustrates the multiple CPM values reporting in EDCA ranging using the FTM frame according to various embodiments of the present disclosure;

FIG. 10C illustrates CPM reporting in TB and non-TB ranging using the LMR frame according to various embodiments of the present disclosure;

FIG. 10D illustrates the multiple CPM reporting in TB and non-TB using the LMR frame according to various embodiments of the present disclosure;

FIG. 10E illustrates the timestamp measurement report subfield of RSTA/ISTA passive TB ranging measurement report frame according to various embodiments of the present disclosure;

FIG. 11 illustrates a flow diagram of a method performed by an RSTA for enabling carrier phase measurement and reporting in FTM according to various embodiments of the present disclosure;

FIG. 12 illustrates a flow diagram of an example of a method performed by an ISTA for enabling carrier phase measurement and reporting in FTM according to various embodiments of the present disclosure; and

FIG. 13 illustrates a flow diagram of an example of a method for wireless communication performed by a station device according to embodiments of the present disclosure.

### DETAILED DESCRIPTION

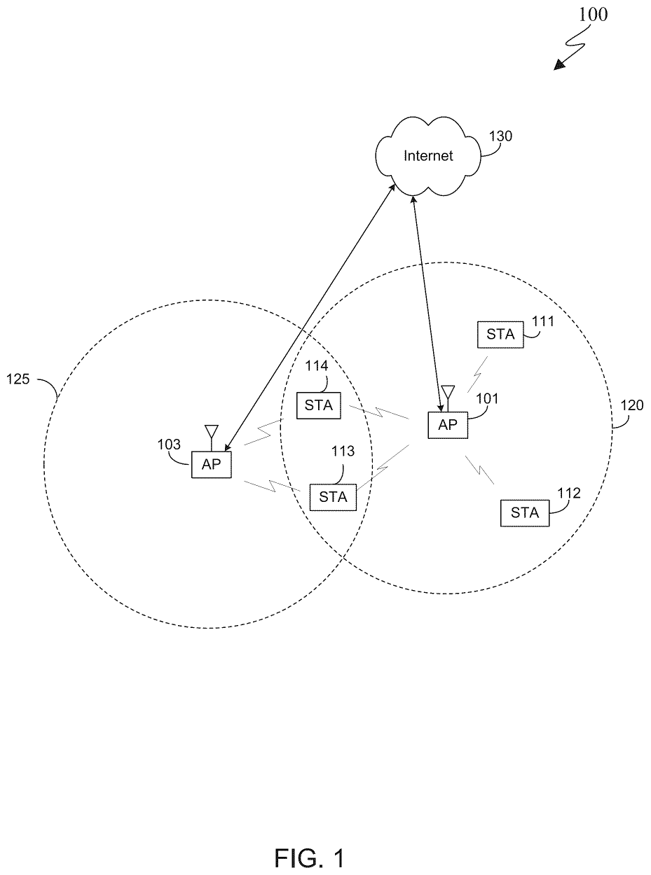

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE std. 802.11-2020,“Wireless LAN Medium Access Control (MAC) and Physical Layer (PHY) Specification”; [2] IEEE P802.11az/D5.0.

Embodiments of the present disclosure recognize that by using the carrier phase-information measured by an RSTA and ISTA, i.e., the angle of the complex channel estimate measured at the 0th-subcarrier, an accurate relative range estimation can be performed whose precision is not limited by the system bandwidth, unlike the range estimate obtained from the conventional FTM protocol. In addition, embodiments of the present disclosure recognize that this relative range estimation can be used to improve the range estimates that are obtained from the conventional FTM protocol. However, the current FTM protocols do not enable reporting of the carrier-phase information and thus cannot exploit the benefits of this new relating ranging method.

Accordingly, embodiments of the present disclosure can provide mechanisms to report the carrier-phase information during the FTM protocol between an ISTA and RSTA. These reports can enable carrier-phase based relative ranging, and also can be used for improving the accuracy of conventional FTM ranging.

Embodiments of the present disclosure provide a method for an ISTA and RSTA to indicate capability for reporting of carrier phase measurements in all of the existing FTM ranging protocols. In addition, embodiments of the present disclosure provide a method for an ISTA to request reporting of carrier phase measurements to an RSTA when initiating an FTM ranging session. Further, embodiments of the present disclosure provide a method for an RSTA (and optionally an ISTA) to report the carrier phase measurements during the FTM measurement reporting phase. Further still, embodiments of the present disclosure provide mechanisms for enabling carrier-phase-based relative ranging via the carrier-phase information and utilizing the carrier-phase information to improve FTM ranging accuracy. In addition, embodiments of the present disclosure provide additional methods for reporting of CFO and LoS assessment during the FTM measurement reporting phase.

For simplicity, embodiments of the present disclosure discuss carrier-phase reporting in WiFi ranging as performed by a STA (i.e., a non-AP STA), however it is understood that an AP (i.e., an AP STA) can also perform carrier-phase reporting in WiFi ranging. It is also understood that non-AP STAs and AP STAs are both IEEE 802.11 node devices (or nodes), which may also be referred to as WI-FI node devices (or nodes). Accordingly, discussion herein below of actions performed by a STA may be performed by any appropriate IEEE 802.11 node.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating carrier-phase reporting in WiFi ranging. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

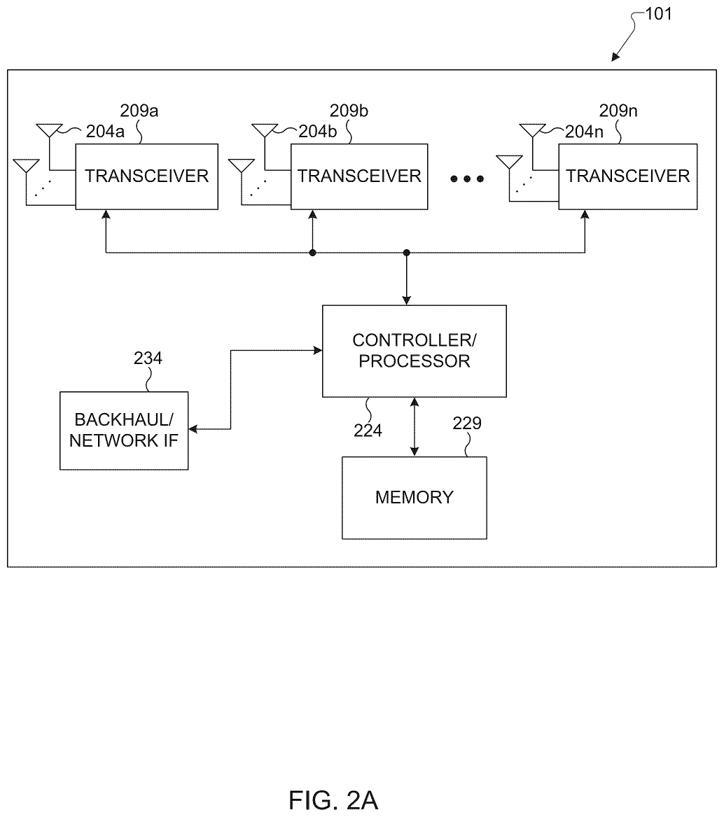

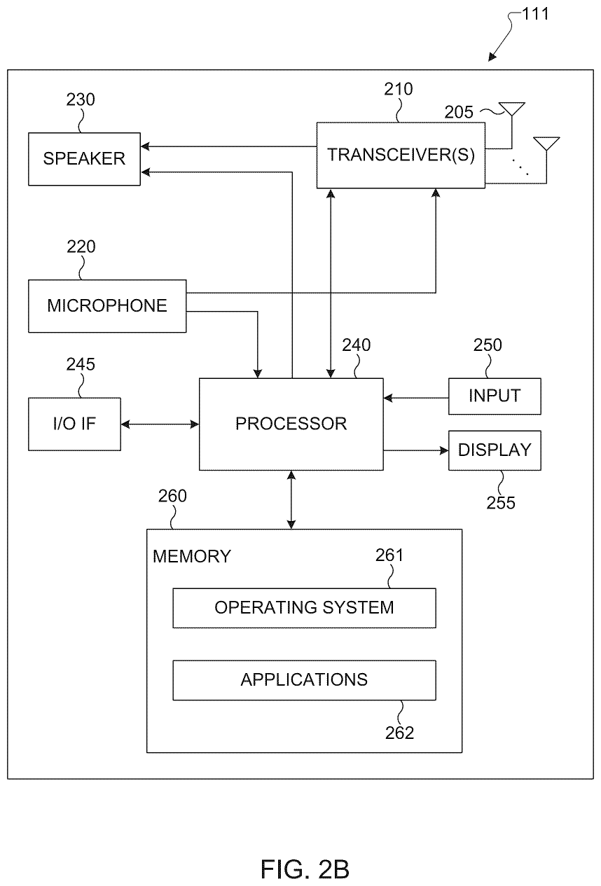

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating carrier-phase reporting in WiFi ranging. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating carrier-phase reporting in WiFi ranging. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate carrier-phase reporting in WiFi ranging. In some embodiments, the processor 240 includes at least one microprocessor or microcontroller.

The processor 240 is also capable of executing other processes and programs resident in the memory 260, such as operations for facilitating carrier-phase reporting in WiFi ranging. The processor 240 can move data into or out of the memory 260 as required by an executing process. In some embodiments, the processor 240 is configured to execute a plurality of applications 262, such as applications for facilitating carrier-phase reporting in WiFi ranging. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Fine Timing Measurement (FTM) is a wireless network management procedure that allows a STA to determine its range, relative range and its direction to or from another STA using Time Of Flight (TOF), time difference of arrival and phase measurement. For a STA to obtain its location, the STA may perform this procedure with multiple STAs whose locations are known. The protocol was first proposed in IEEE 802.11-2016 (also called 802.11mc) and has since been updated in the newly drafted IEEE 802.11az standard.

An FTM session is an instance of an FTM procedure between an initiating station (ISTA) and a responding station (RSTA) that have an associated set of parameters. The capability of performing FTM initiation and response are indicated in FTM Responder field and FTM Initiator field of the Extended Capabilities element. It includes 3 phases: Negotiation->measurement exchange->termination. An ISTA can have multiple concurrent FTM sessions with different RSTAs.

### Negotiation Phase

In some embodiments, in the negotiation phase, the ISTA negotiates with the RSTA the key parameters, such as frame format and bandwidth, number of bursts, burst duration, the burst period, and the number of measurements per burst, etc., to use for the ranging. For this parameter negotiation, the ISTA transmits an initial FTM request (IFTMR) frame, wherein the parameters are included in the FTM parameters element (in case of EDCA ranging) or in Ranging Parameters element (in case of TB/non-TB/Passive TB ranging). The RSTA responds with an initial FTM (IFTM) frame within a time period (e.g., 10 ms) including either the FTM Parameters element (in case of EDCA ranging) or Ranging Parameters element (in case of TB/non-TB/Passive TB ranging). These parameters may be same as what were requested by the ISTA, or they may be over-ridden by RSTA for implementation dependent reasons. After the negotiation is completed successfully, an FTM session is established. In case of TB or non-TB ranging, a secure FTM session is established when an ISTA and an RSTA establish a pairwise transient key security association (PTKSA) and use it to exchange a Protected FTM Request Action frame (as the IFTMR frame), and the corresponding Protected FTM Action frame (as the IFTM frame).

### Negotiation for EDCA Ranging:

In some embodiments, the IFTMR frame has the Trigger field set to 1 and has a set of scheduling parameters that describe the ISTA's availability for measurement exchange in a FTM Parameters field of the IFTMR frame. These parameters can include Number of Bursts Exponent, Burst Duration, Min Delta FTM, Partial TSF Timer, FTMs per Burst, burst Period, etc. If the request is successful, the RSTA can indicate, in the Format And Bandwidth subfield of the FTM Parameters field of IFTM frame, a format and bandwidth that can be used. The indication can comply with what the ISTA supports. When the RSTA cannot support the ISTA's Min Delta FTM or Number of Bursts Exponent constraints or cannot fulfill the request by the ISTA, the RSTA sets the Status Indication field accordingly in the IFTM frame and the FTM session ends.

### Negotiation of TB and Non-TB Ranging:

In some embodiments, for TB and non-TB ranging measurement exchange, the IFTMR and IFTM frames include a Ranging Parameters element containing the non-TB specific sub-element or the TB specific sub-element. If the ISTA does not intend to share measurement results with the RSTA, the ISTA sets the I2R LMR Feedback subfield in the Ranging Parameters field, in the IFTMR frame, to 0. When the I2R LMR Feedback subfield in the IFTMR frame is equal to 1, then the RSTA sets the I2R LMR Feedback subfield to 1 to indicate it requests the ISTA to transmit the I2R LMR or to 0 otherwise. The ISTA includes one ISTA Availability Window element in the TB specific sub-element in the IFTMR frame indicating its availability for TB ranging as well as the requested periodicity. The periodicity can be expressed, for example, in units of 10 TUs and can be a multiple of the Beacon Interval of the RSTA. The RSTA includes a TB-specific sub-element in an IFTM frame and includes an RSTA Availability Window element in the IFTM frame. The Availability Window Information field represents the availability window assigned by the RSTA to the ISTA.

### Passive TB Ranging:

In some embodiments, the negotiation mechanism for passive TB ranging can be similar to TB ranging with a few differences. Firstly, an ISTA intending to set up a passive TB ranging session with an RSTA may set the Passive TB Ranging field in the TB specific sub-element of an IFTMR frame it transmits to the RSTA to 1. To assign an ISTA a passive TB ranging session, the RSTA can respond with the Passive TB Ranging subfield in the Ranging Parameters field set to 1 in the corresponding IFTM frame. In addition, each of the access points operating as an RSTA announces the timing and bandwidth of its ranging availability window for passive TB ranging in its beacon in an RSTA Availability Window element. This is so that a passive STA (PSTA) can be aware of the time when the FTM frames can be passively observed.

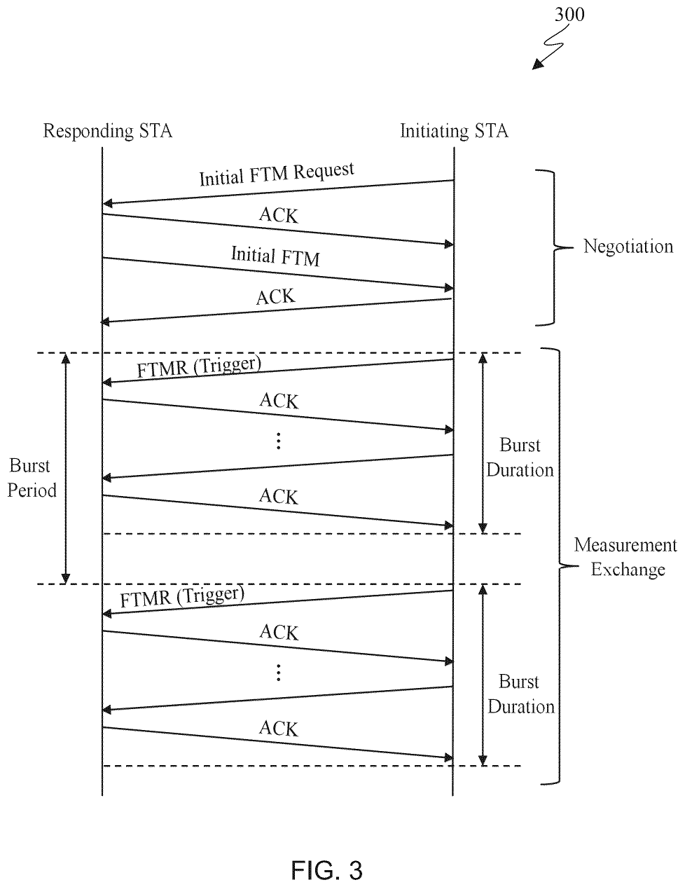

FIG. 3 illustrates an example of the frame exchange during the measurement phase of enhanced distribution channel access (EDCA) ranging 300 according to various embodiments of the present disclosure. The embodiment of the example of the frame exchange during the measurement phase of enhanced distribution channel access (EDCA) ranging 300 shown in FIG. 3 is for illustration only. Other embodiments of the example of the frame exchange during the measurement phase of enhanced distribution channel access (EDCA) ranging 300 could be used without departing from the scope of this disclosure.

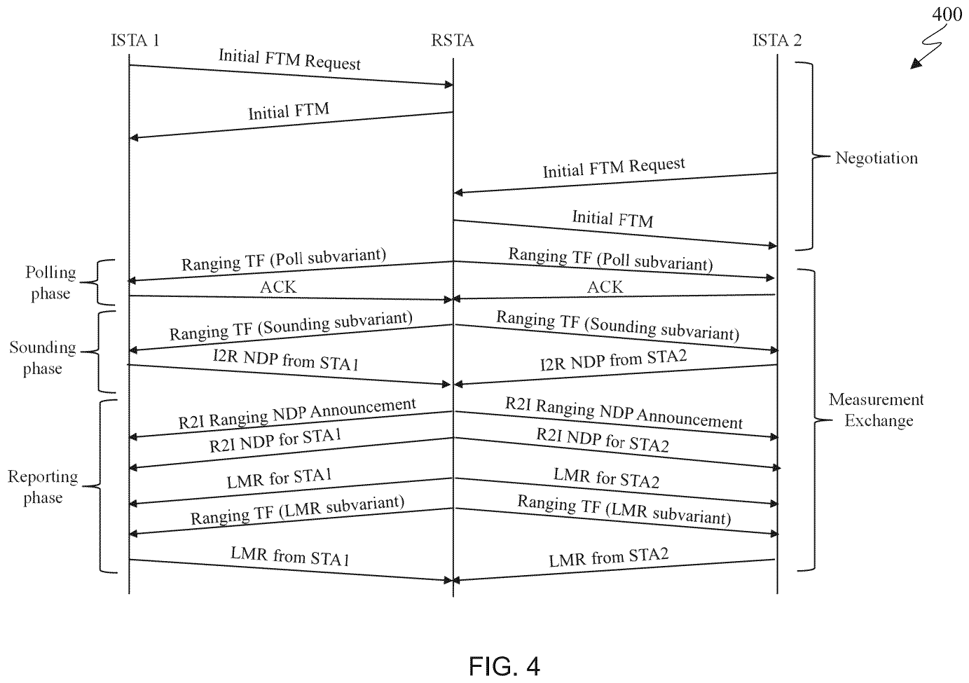

FIG. 4 illustrates an example of the frame exchange during the measurement phase of trigger-based (TB) ranging 400 according to various embodiments of the present disclosure. The embodiment of the example of the frame exchange during the measurement phase of trigger-based (TB) ranging 400 shown in FIG. 4 is for illustration only. Other embodiments of the example of the frame exchange during the measurement phase of trigger-based (TB) ranging 400 could be used without departing from the scope of this disclosure.

### Measurement Phase

In some embodiments, the frequency of the clock used for FTM timestamps is derived from same reference oscillator as the transmit center frequency. The measurement phase can comprise a periodic sequence of bursts, and each burst can comprise one or more (Fine Time) measurements. The duration of a burst and the number of measurements therein are defined by the parameters burst duration and FTMs per burst. The bursts are separated by interval defined by the parameter burst duration.

### Measurement Exchange in EDCA Ranging:

In some embodiments, a measurement exchange phase includes a periodic sequence of bursts. The timing of burst instances is determined by Partial TSF timer, Burst duration and Burst period in the FTM Parameters element of IFTM (sent during negotiation). The first burst instance can start at the value indicated by the partial TSF timer subfield of IFTM frame sent by RSTA. The TSF Synchronization Information field in FTM/IFTM frame can be used by the ISTA to synchronize its TSF with the RSTA's in order to determine the start time of subsequent bursts. The ISTA can request the RSTA to start the burst instances as soon as possible (ASAP) by setting ASAP subfield of the FTM Parameters element to 1.

In some embodiments, at the beginning of each burst instance, the ISTA indicates its availability by transmitting an FTMR frame without a FTM parameters element, but with the FTM Synchronization Information element present and with Trigger field set to 1. In response, the RSTA transmits an ACK (acknowledge) frame and can transmit “FTMs Per Burst” number of FTM frames before end of the burst instance. Subsequent FTM frames in a burst may not include the Synchronization Information element or FTM Parameters elements and are spaced apart by at least Min Delta FTM. These frame exchanges are illustrated in FIG. 3.

In some embodiments, both the FTM frame and the corresponding ACK are transmitted using a single transmit chain. Each FTM frame and its ACK within a session create one set of measured values. The RSTA captures the time at which the FTM frame is transmitted (t1) and ACK arrives (t4). The ISTA captures the time at which the FTM frame arrives (t2) and the time at which the ACK response is transmitted (t3). In next FTM frame, in the same or the subsequent burst, the RSTA includes values of t1 and t4 in the TOD and TOA fields, respectively. These timestamp values (t1 and t4) are measured according to the RSTA's clock (without applying any frequency offset correction to the time bases). Using these 4 values the ISTA can estimate the round-trip time (RTT) as:

$$RTT = ( t {4}^{′} - t {1}^{′} ) - ( t 3 - t 2 ) ,$$

where t4′, t1′ are inferred from t4, t1 at the ISTA using an implementation dependent way. The FTM procedure can also be used to synchronize a local clock between STAs.

$$clock offset = [ ( t 2 - t {1}^{′} ) - ( t {4}^{′} - t 3 ) ] / 2$$

In some embodiments, the ISTA may track this clock offset over time to derive an estimate of the difference between the ISTA's time base and the RSTA's time base, thereby improving the accuracy of its derivation of t4′, t1′ from t4, t1. If an ACK is not received, the FTM frame is not retransmitted. Instead, the same info (except dialog token) is included in the next scheduled FTM frame, this is called the FTM retransmission procedure. When neither an ACK to an IFTM frame nor an FTMR frame are received by the RSTA, it does not terminate the FTM session before the time indicated by partial TSF+Burst Duration (i.e., end of first burst). During an FTM session, an ISTA can terminate the current session or request a new session with modified parameters by transmitting an FTMR frame with Trigger field set to 1 and including a new FTM parameters element. This FTMR frame can be the IFTMR frame for the new session.

### Measurement Exchange in TB Ranging:

In some embodiments, it is a dynamic TB variant of FTM, that contains one or more scheduled periodic availability windows, and multiple ISTAs can participate simultaneously (to reduce overhead). Number of ISTAs participating can vary across the windows (hence dynamic). Each availability window can comprise one or more of a triplet of phases: Polling, Measurement Sounding, and/or Measurement Reporting. In some cases, within each availability window the RSTA and ISTAs do not transmit or trigger transmission of any Data frames; in some cases, they only perform ranging activities related to Polling, Measurement Sounding, and/or Measurement Reporting phases, as well as signaling of modification of availability window parameters. Each availability window by default comprises a single Transmission Opportunity (TXOP) and may be extended to multiple TXOPs by announcement, if a single TXOP is insufficient to accommodate all ISTAs that responded to the poll. Each availability window typically contains a single poll, where the RSTA polls all the ISTAs assigned to that availability window. If the available bandwidth is insufficient to accommodate all ISTAs in one poll, more extra polling/sounding/reporting triplets can be scheduled within the availability window. During the availability window, measurement resources and results are made available to each ISTA whose poll response was received at the RSTA. Inside Availability Windows allocated to itself, an ISTA does not transmit any frame except when assigned UL resources by a TF transmitted by the RSTA. The procedure within each of the phases are as shown below:
Polling phase of TB ranging: RSTA transmits a Ranging Trigger frame (TF) of subvariant Poll but only one of them, and gets a response from ISTAs. Each RU in the Ranging TF is only allocated to only one ISTA. Any ISTA addressed by a User Info field in a Ranging TF of subvariant Poll frame that intends to participate in the measurement sequence within this availability window sends a CTS-to-self in an S-MPDU within an HE TB PPDU in its designated RU allocation as identified in the TF Ranging Poll frame. Note: S-MPDU is an A-MPDU with only one MPDU (MAC (media access control) Protocol Data Unit) with 1 in the EOF field. More TF subfield of Common Info field of the TF is used to indicate if there are more TFs in the window.
Measurement sounding phase of TB ranging: It starts short inter-frame spacing (SIFS) after the end of polling phase. It includes one or more Ranging TFs of subvariant Sounding, allocating uplink (UL) resources to the ISTAs. Each Ranging TF of subvariant Sounding allocates UL spatial streams for one or more ISTAs' I2R NDP frames that are multiplexed in spatial domain, each occupying the full bandwidth. SIFS time after receiving the I2R NDPs from the ISTAs, the RSTA transmits an R2I Ranging NDP Announcement frame followed by a R2I NDP. The Ranging NDP Announcement frame's STA Info fields specify all the ISTAs that should use the R2I NDP, which include the ISTAs that were allocated UL spatial streams in the Ranging TF frame of subvariant sounding. The spatial streams and BW of the Ranging TF and Ranging NDP announcement comply with the capabilities of each of the indicated ISTAs. Both RSTA and the ISTAs perform RTT measurements by capturing the timestamps of the NDPs. The ISTA can record the time the I2R NDP is transmitted (t1), and the RSTA the time it arrives (t2). Similarly, RSTA captures the time R2I NDP is transmitted (t3) and ISTA the time it arrives (t4). The RSTA uniquely identifies each Ranging NDP Announcement frame by the Sounding Dialog Token Number field. Thus, each measurement instance is associated with a Sounding Dialog Token Number field value. To aid in synchronizing the TSF time at the ISTAs, the RSTA includes in the Ranging NDP Announcement, a STA info field with AID11=2044, with the Partial TSF subfield set to partial TSF of RSTA at time of sending the Ranging TF of subvariant Poll.
Reporting phase of TB ranging: It begins SIFS after the measurement sounding phase. Results of the timing measurements are carried in LMR frames, which include the TOA, TOD, CFO Parameter fields etc. First, the RSTA transmits an R2I LMR to all ISTAs that were allocated resources in the preceding measurement sounding phase. All the R2I LMR frames can be carried in one HE MU PPDU, where each RU contains only one user, and the TOA carries value of t2 and TOD carries value of t3. Feedback type of LMR can be immediate (values correspond to current availability window) or delayed (values correspond to previous window). The Dialog Token subfield in LMR matches the Sounding Dialog Token in Ranging NDP announcement frame for which TOA and TOD are reported. Using these values, the ISTA can estimate the round-trip time (RTT) as:

$$RTT = ( t 4 - t 1 ) - ( t {3}^{′} - t {2}^{′} ) ,$$

where t2′, t3′ are determined from t2, t3 in an implementation dependent way at ISTA. If the I2R LMR was negotiated by one or more ISTAs, then SIFS time after transmitting out the R2I LMR, the RSTA transmits a TF Ranging LMR to solicit the I2R LMR frame(s). This TF can allocate uplink resources to ISTAs that negotiated I2R LMR and were allocated resources in the preceding measurement sounding phase. The RSTA allocates each RU in the TF Ranging LMR to only one ISTA. In response to the TF Ranging LMR, each addressed ISTA responds by transmitting an I2R LMR frame, where the TOD carries the value of t1 and TOD carries value of t4. If I2R LMR reporting was negotiated, then the ISTA includes a CFO parameter in the I2R LMR as well. The ISTA estimates the CFO parameter based on the PPDU carrying the Ranging TF of subvariant Sounding that solicits the I2R NDP from the ISTA. The RSTA may account for clock rate differences between ISTA and RSTA based on the CFO parameter included in the received I2R LMR. The mechanism can be implementation specific. If a Secure FTM session is negotiated, the LMR is transmitted in Protected Fine Timing Action frames.

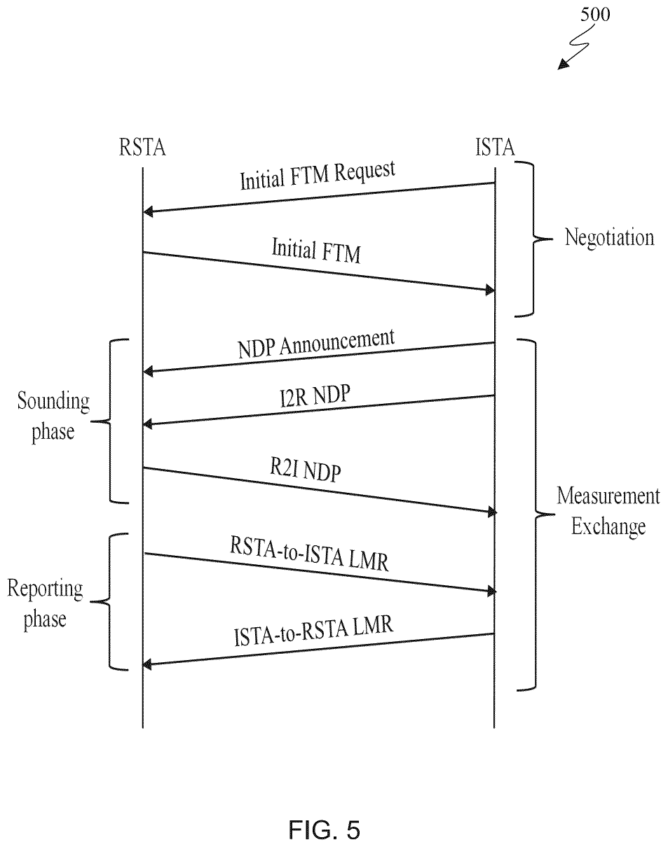

FIG. 5 illustrates an example of the frame exchange during the measurement phase of non-TB ranging 500 according to various embodiments of the present disclosure. The embodiment of the example of the frame exchange during the measurement phase of non-TB ranging 500 shown in FIG. 5 is for illustration only. Other embodiments of the example of the frame exchange during the measurement phase of non-TB ranging 500 could be used without departing from the scope of this disclosure.

### Measurement Exchange in Non-TB Ranging:

In some embodiments, the protocol operates in an ISTA centric scheduling. RSTA can only limit the frequency with which the ISTA can initiate measurements by setting a minimum time interval for the ranging exchange. It can comprise two phases: Measurement Sounding and Measurement Reporting.
Sounding phase of non-TB ranging: ISTA initiates by transmitting a Ranging NDP Announcement frame to RSTA and a I2R NDP SIFS after. In response, RSTA transmits an R2I NDP. The Min/Max Time Between Measurements are set in the fields of the IFTMR and IFTM frames (during negotiation). ISTA maintains a Sounding Dialog Token counter modulo 64 for each FTM session. It is incremented before transmission of each Ranging NDP announcement frame to the RSTA, and its value is included in the NDPA. Both RSTA and ISTA perform RTT measurements by capturing the timestamps of the NDP. The ISTA can record the time the I2R NDP is transmitted (t1), and the RSTA the time it arrives (t2). Similarly, RSTA captures the time R2I NDP is transmitted (t3) and ISTA the time it arrives (t4).
Reporting phase of non-TB ranging: The reporting phase can be similar to TB-ranging. It starts a SIFS after measurement phase and it can comprise LMR frame transmissions with immediate or delayed feedback, which include the TOA, TOD, CFO Parameter fields etc. First, the RSTA transmits an R2I LMR to the ISTA where the TOA carries value of t2 and TOD carries value of t3. The dialog token of the LMR frame are copied from the Sounding Dialog Token Number of the NDPA from ISTA whose measurements are included in the LMR. Using these values, the ISTA can estimate the round-trip time (RTT) as:

$$RTT = ( t 4 - t 1 ) - ( t {3}^{′} - t {2}^{′} ) ,$$

where t2′, t3′ are determined from t2, t3 in an implementation dependent way at ISTA. If I2R LMR feedback is negotiated, after SIFS time of receiving the R2I LMR frame, the ISTA can transmit the I2R LMR frame to the RSTA. In the non-TB ranging, both RSTA and ISTA measure the CFO values independently based on reception of I2R NDP and R2I NDP respectively. They are not reported in LMRs (the CFO parameter fields are reserved in non-TB ranging). The RSTA and ISTA may account for clock rate differences between ISTA and RSTA respectively based on their own measured CFO value.

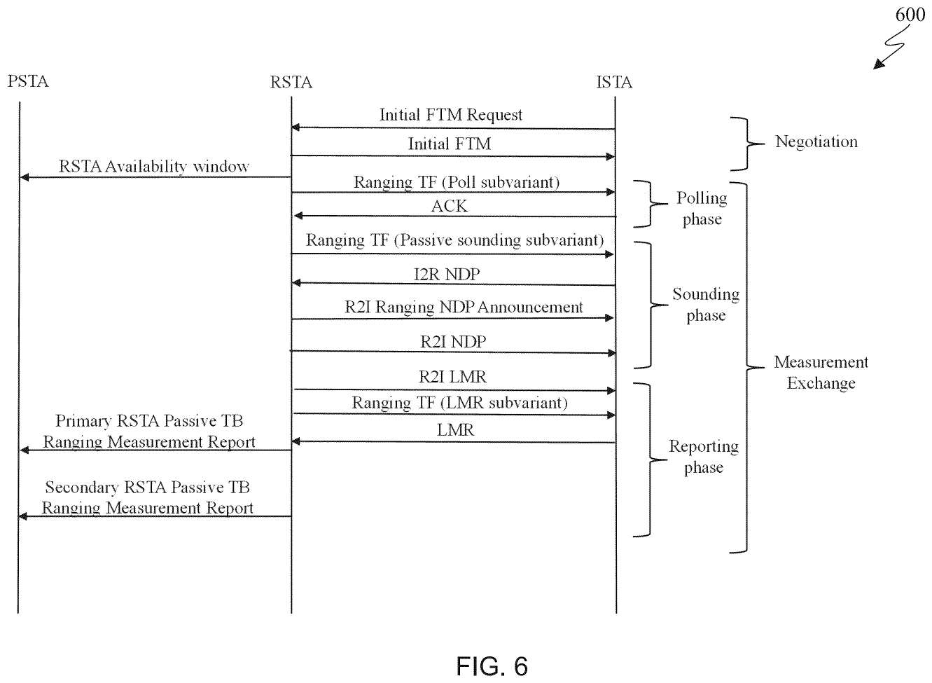

FIG. 6 illustrates an example of the frame exchange during the measurement phase of passive TB ranging 600 according to various embodiments of the present disclosure. The embodiment of the example of the frame exchange during the measurement phase of passive TB ranging 600 shown in FIG. 6 is for illustration only. Other embodiments of the example of the frame exchange during the measurement phase of passive TB ranging 600 could be used without departing from the scope of this disclosure.

### Measurement Exchange in Passive TB Ranging:

In some embodiments, passive TB ranging mode is a variant of the TB ranging mode. It involves frame exchanges between one or more RSTAs and one or more ISTAs which perform trigger based FTM frame exchanges, while also enabling some passive STAs (PSTAs) to be able to estimate their differential range passively without transmitting any frames. In passive TB ranging, each availability window can comprise one or more of a triplet of phases: Polling, Measurement Sounding, and/or Measurement Reporting. The procedure within each of the phases are as shown below:
Polling phase of passive TB ranging: This phase can be identical to TB ranging.
Measurement sounding phase of TB ranging: It starts SIFS after the end of polling phase. It includes one or more Ranging TFs of subvariant Passive Sounding to solicit responses from one or more ISTAs. Each Ranging TF of subvariant Passive Sounding solicits a response from only one ISTA which is identified by the single User Info field of the TF. An ISTA addressed by the AID/RSID in the Ranging TF of subvariant Passive Sounding can transmit a HE Ranging NDP a SIFS time after the reception of the Ranging TF addressed to it. Subsequent Ranging TFs of subvariant Passive Sounding can be sent serially, a SIFS after receiving the HE Ranging NDP, to sound other ISTAs. SIFS time after receiving all the I2R Ranging NDPs from the ISTAs, the RSTA transmits an R2I Ranging NDP Announcement frame followed by a R2I NDP. The Ranging NDP Announcement frame's STA Info fields specify all the ISTAs that should use the R2I NDP, which include the ISTAs that were sounded by sending a Ranging TF frame of subvariant Passive Sounding. Both RSTA and the ISTAs perform RTT measurements by capturing the timestamps of the NDPs. The ISTA can record the time the I2R NDP is transmitted (t1), and the RSTA the time it arrives (t2). Similarly, RSTA captures the time R2I NDP is transmitted (t3) and ISTA the time it arrives (t4). The RSTA uniquely identifies each Ranging NDP Announcement frame by the Sounding Dialog Token Number field. Thus, each measurement instance is associated with a Sounding Dialog Token Number field value. If negotiated, the RSTA and ISTA also perform phase shift feedback time of arrival computations for the reception time of I2R NDPs and the reception of R2I NDP, respectively. In addition, optionally an ISTA may also measure and report either the time of arrivals, or both the time of arrivals and the phase shift feedback time of arrivals, when it receives the HE Ranging NDPs transmitted by the other ISTAs participating in the passive TB ranging exchange. By reporting the timestamps for when it received the other ISTAs NDP transmissions, the quality of the location estimate for a PSTA listening in to the passive TB ranging exchanges can be improved.
Reporting phase of TB ranging: It begins SIFS after the measurement sounding phase. In this phase, first an RSTA sends an RSTA Passive TB Ranging Measurement Report frame followed by a Ranging TF of subvariant Report to the one or more ISTAs that sent an HE Ranging NDP. In response to the Ranging TF of subvariant Report, each solicited ISTA transmits an ISTA Passive TB Ranging Measurement Report frame to report its I2R LMR a SIFS time after the transmission of the Ranging TF of subvariant Report. This TF includes the CFO parameters of ISTA with respect to the RSTA, the TOA, TOD time stamps estimated in the measurement sounding phase, etc. After obtaining all the ISTA Passive TB Ranging Measurement Reports, the RSTA sends the Primary and Secondary RSTA Broadcast Passive TB Ranging Measurement Report frames, the Primary a SIFS time after receiving the ISTA Passive TB Ranging Measurement Report frames from the ISTA and the Secondary a SIFS following the Primary. The primary report includes the RSTA Passive TB Ranging Measurement Report while the secondary report includes the ISTA Passive TB Ranging Measurement Reports. These primary and secondary report frames are used by PSTAs to obtain the necessary information to perform the differential ranging. In particular, a PSTA may use the ISTA's and RSTA's timestamps, together with its own measured TOAs of the ranging NDPs, t5 and t6, to calculate its differential time of flight to the RSTA and the ISTA. The differential time-of-flight (DToF) from PSTA to RSTA and ISTA (DToF_PRI) is defined by:

$${DToF}_{PRI} = {ToF}_{PR} - {ToF}_{PI} = t 6 - t 5 - 0.5 \times t {3}^{′} + 0.5 \times t {2}^{′} - 0.5 \times t {4}^{′} + 0.5 \times t 1 ;$$

where t1′ and t4′ are the time at which the I2R NDP was transmitted from the ISTA and the time at which the R2I NDP was received by the ISTA, respectively, converted by the PSTA from the ISTA's time basis to the PSTA's time basis and t2′ and t3′ are the time at which the I2R NDP was received by the RSTA and the time at which the R2I NDP was transmitted by the RSTA, respectively, converted by the PSTA from the RSTA's time basis to the PSTA's time basis.

### Termination Phase

### Termination in EDCA Ranging:

In some embodiments, an FTM session terminates after the last burst instance as indicated by number of bursts exponent, bursts duration, FTMs per Burst and Burst Period subfields in the FTM Parameters field of the IFTM frame. An FTM session may be terminated early by:
An RSTA sending an FTM frame with dialog token set to 0 during an active burst.
An ISTA transmitting an FTMR frame with trigger field set to 0.

### Termination in TB Ranging:

In some embodiments, a TB ranging FTM session may be terminated if ISTA fails to respond to a Ranging TF of subvariant Poll and fails to receive one Ranging TF of subvariant Sounding (or Secure Sounding) within the Max Session Expiry interval. This interval is specified in the Max Session Exp field of the TB Ranging specific sub-element of the Ranging Parameters transmitted in the IFTM frame (during negotiation). A session can be terminated by ISTA by sending an FTM Request frame with Trigger=0. A session can be terminated by RSTA by transmitting an AMPDU with an R2I LMR frame and a FTM frame, with Dialog Token field set to 0. The Follow up dialog token field is also set as 0.

### Termination Non-TB Ranging:

In some embodiments, a session can be terminated if ISTA does not initiate a ranging instance within ‘Max Time Between Measurements’ of the last ranging instance. This value is reported in the Max Time Between Measurements subfield of the Ranging Parameters field of the IFTM frame transmitted in the negotiation phase. A session can be terminated by ISTA by sending an FTM Request frame with Trigger=0. A session can be terminated by RSTA by transmitting an AMPDU with an R2I LMR frame and a FTM frame, with Dialog Token field set to 0. The Follow up dialog token field is also set as 0.

### Termination in Passive TB Ranging:

The procedure can be similar to TB ranging.

Converting Measurements to Range and Location Estimates

In some embodiments, for positioning and proximity apps, the RTT (e.g., measured in seconds units) between the two STAs is translated into a distance or range as:

$$d = \frac{RTT}{2} \times 3 \times 1 {0}^{8} ( in meters ) .$$

In some embodiments, each FTM of the burst yields a distance sample, with multiple distance samples per burst. Given multiple FTM bursts and multiple measurements per burst, the distance samples can be combined in different ways to produce a representative distance measurement. For example, the mean distance can be reported, the median, or some other percentile. Furthermore, other statistics such as the standard deviation can be reported as well to be used by the positioning app.

In some embodiments, for localization, such range measurements may be required between ISTA from multiple RSTAs. If the exact locations of the RSTAs are not known, it can request one RSTA to disclose its range from the other RSTAs. An interested ISTA can request an RSTA, that advertises FTM Range Report Capability Enabled equal to true in the RM Enabled Capabilities element (included in beacons, association response, etc.), to measure and report the ranges between the RSTA and other nearby APs. The request is made by transmitting an FTM Range Request element in a Spectrum Measurement Request or Radio Measurement Request frame. The requesting STA may request a single set of measurements by setting the number of repetitions field to 0 in the request frame or can request a periodic sequence of measurements by setting number of repetitions to >0. A STA that advertises FTM Range Report Capability Enabled equal to true responds to an FTM Range request frame with an FTM Measurement Range report element. The values included in the report can either be new measurements or previous measurements taken that fit within the maximum age sub-element of the request. If new measurements are required to meet the ‘Minimum AP Count’, then the responding STA can start the FTM measurements with those APs after a randomized delay. The RSTA makes attempts till it meets the Minimum AP count or till it has tried with all the listed APs. For each failed attempt, the RSTA records an entry in the report. The RSTA transforms the measurements obtained from each FTM procedure with an AP into a range and a maximum error between itself and AP while accounting for any clock offsets.

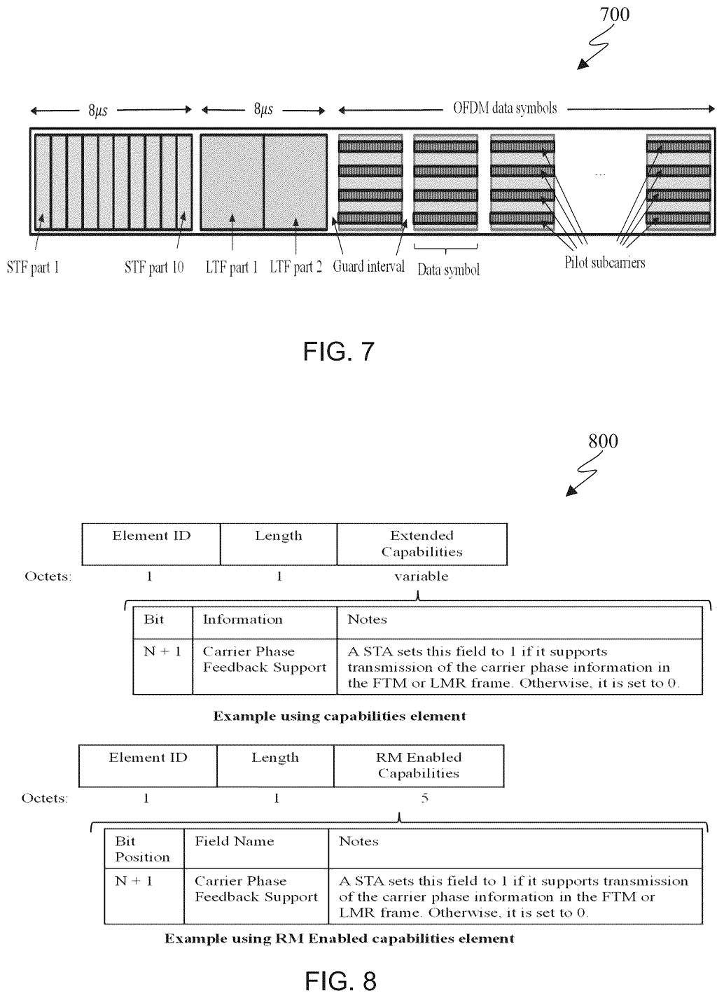

FIG. 7 illustrates an example of a frame structure 700 in the IEEE 802.11a standard according to various embodiments of the present disclosure. As an example, consider a system setup that has an ISTA and RSTA that are performing EDCA-based FTM based ranging. The involved frame exchanges can be performed using orthogonal frequency division multiplexing (OFDM) over K sub-carriers indexed as: K={−K₁, . . . ,0, . . . , K₂}. Each such frame may have a short training field (STF) and a long training field (LTF), as depicted in FIG. 7.

FIG. 8 illustrates the capability indication for supporting carrier phase measurement and reporting in FTM protocol 800 according to various embodiments of the present disclosure. The embodiment of the capability indication for supporting carrier phase measurement and reporting in FTM protocol 800 shown in FIG. 8 is for illustration only. Other embodiments of the capability indication for supporting carrier phase measurement and reporting in FTM protocol 800 could be used without departing from the scope of this disclosure.

From the STF and LTF of the i-th FTM frame transmitted in the b-th burst by the RSTA, the ISTA can obtain an estimate the carrier frequency offset (CFO) \hat{ƒ}_{CFO}⁽¹⁾ and the channel on the k-th subcarrier ĥ_{b,i,k}⁽¹⁾. Using these channel estimates, the ISTA can further estimate the carrier-phase for the FTM frame \hat{ψ}_{b,i}⁽¹⁾,i.e., phase of channel on sub-carrier 0, in an implementation specific way. For example,

$${\hat{ψ}}_{b , i}^{( 1 )} = ∠ {\hat{h}}_{b , i , 0}^{( 1 )} or {\hat{ψ}}_{b , i}^{( 1 )} = {\sum }_{k = - A}^{A} ∠ {\hat{h}}_{b , i , k}^{( 1 )} ,$$

$${\hat{ψ}}_{b , i}^{( 1 )} = ∠ [ {\sum }_{k = - A}^{A} ∠ {\hat{h}}_{b , i , k}^{( 1 )} ] ,$$

where A is a design parameter, etc., can be used. Note that if the channel estimate ĥ_{b,i,o}⁽¹⁾ is not available for the 0-subcarrier,\hat{ψ}_{b,i}⁽¹⁾ can still be extrapolated from the available sub-carriers. Similarly using the STF and LTF of the i-th ACK frame transmitted in the b-th burst by the ISTA, the RSTA can estimate the CFO \hat{ƒ}_{CFO}⁽²⁾, the channel on the k-th subcarrier as ĥ_{b,i,k}⁽²⁾ and the carrier phase \hat{ψ}_{b,i}⁽²⁾ for the ACK frame. It can be shown that using the values of \hat{ψ}_{b,i}⁽¹⁾, \hat{ψ}_{b,i}⁽²⁾ with the FTM timing measurements t1, t2, t3, t4 corresponding to the frame exchange (b, i) and one or both of \hat{ƒ}_{CFO}⁽¹⁾, \hat{ƒ}_{CFO}⁽²⁾, a precise relative range estimate can be obtained, viz., an estimate of the change in distance between two FTM measurements. The accuracy of this estimation can be much higher than the relative range estimate that is possible just from using t1, t2, t3, t4. Additionally, the information in the parameters \hat{ψ}_{b,i}⁽¹⁾, \hat{ψ}_{b,i}⁽²⁾, \hat{ƒ}_{CFO}⁽¹⁾, \hat{ƒ}_{CFO}⁽²⁾ can also be exploited to improve the conventional RTT estimate that is obtained in FTM protocol (that only uses t1, t2, t3, t4). Embodiments of the present disclosure provide methods for the reporting of such carrier-phase measurements at the ISTA and RSTA.

In some embodiments, it may be mandatory for all STAs beyond a specific WiFi generation to support such carrier phase reporting. In some embodiments, it may be an optional feature, and so the STA may report, in a Capabilities element, its capability to support transmission of the carrier-phase measurements within the FTM protocol. An AP STA can include such a Capabilities element in Probe Response, Association Response and/or Beacon frames, while a non-AP STA can include such a Capabilities element in a Probe Request or an Association Request frame. As an example, the Capabilities element can be the Extended Capabilities element, and the capability to report carrier-phase measurements within the FTM protocol can be indicated in the Carrier Phase Feedback Support bit as depicted in FIG. 8. In another example, the Capabilities element can be the Radio Measurement Enabled Capabilities element that is transmitted by the STA as depicted in FIG. 8. In some embodiments, the support may be specific to the type of FTM ranging and, correspondingly there may be separate bits in the Capability element for each ranging protocol: “EDCA Ranging Carrier Phase Feedback Support”, “TB Ranging Carrier Phase Feedback Support”, “non-TB Ranging Carrier Phase Feedback Support”, “Passive TB Ranging Carrier Phase Feedback Support”, etc.

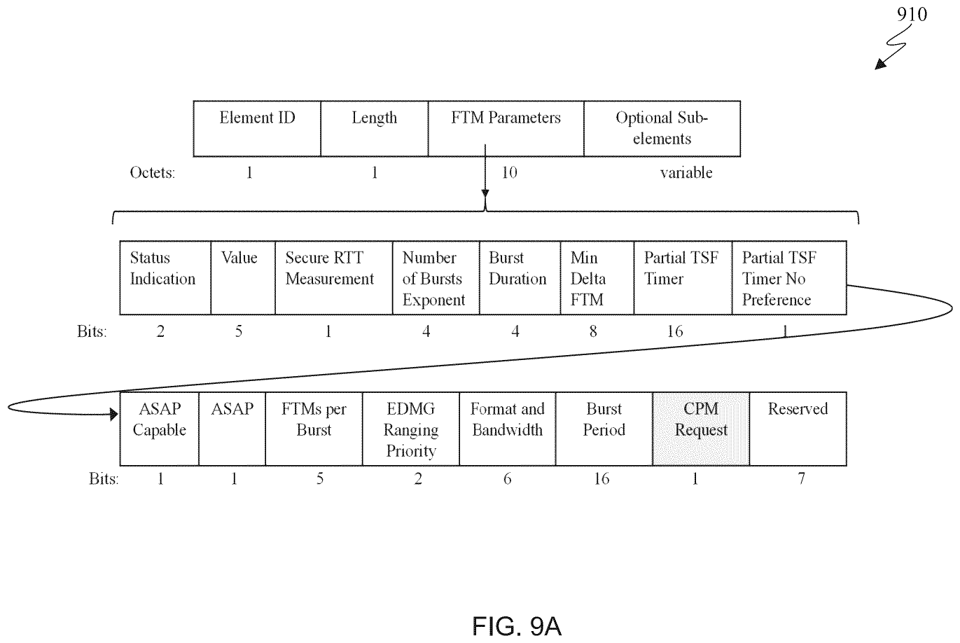

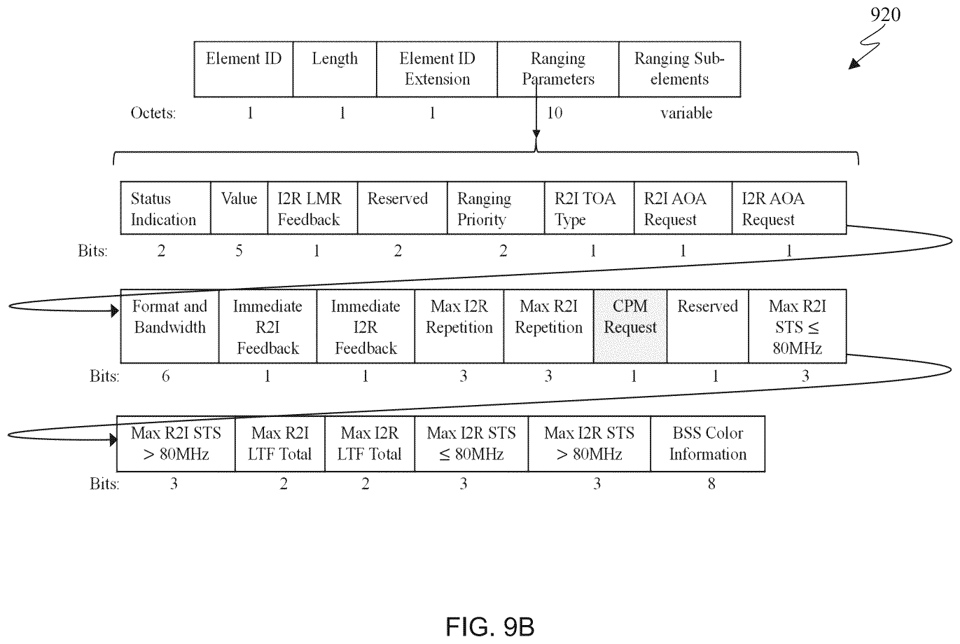

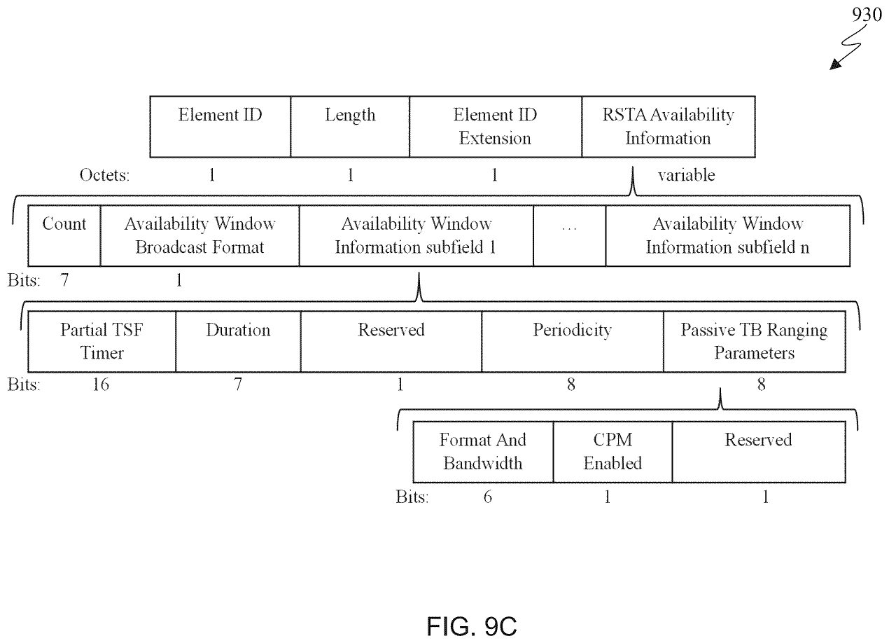

FIG. 9A illustrates a CPM request field in the FTM parameters element 910 according to various embodiments of the present disclosure. The embodiment of the CPM request field in the FTM parameters element 910 shown in FIG. 9A is for illustration only. Other embodiments of the CPM request field in the FTM parameters element 910 could be used without departing from the scope of this disclosure.

FIG. 9B illustrates a CPM request field in the ranging parameters element 920 according to various embodiments of the present disclosure. The embodiment of the CPM request field in the ranging parameters element 920 shown in FIG. 9B is for illustration only. Other embodiments of the CPM request field in the ranging parameters element 920 could be used without departing from the scope of this disclosure.

In some embodiments, it may be mandatory for the RSTA to report the Carrier Phase Measurement (CPM) as part of the FTM ranging procedure. In some embodiments, when an ISTA transmits the IFTMR frame, it can request the Carrier Phase Measurement (CPM) reporting from the RSTA. For example, this request can be carried in the CPM Request field of the FTM Parameters element (in case of EDCA ranging) or the CPM Request field of the Ranging Parameters element (in case of TB, non-TB, or passive TB ranging) that is included in the IFTMR frame, as depicted in FIGS. 9A and 9B respectively. The CPM Request bit is set to 1 to indicate that the ISTA requests the RSTA to report the carrier phase measurement and is set to 0 otherwise. In some variations, there can be a separate field I2R CPM Request for initiator to responder reporting and a separate field R2I CPM Request for responder to initiator reporting, respectively. The ISTA may request such CPM reporting only if the RSTA indicates the capability for such reporting. In some embodiments, along with the CPM Request, the FTM Parameters element or Ranging Parameters element may also have a CPM Subcarrier Index field, indicating the sub-carrier index at which to perform the carrier phase measurement. In the IFTM frame transmitted by the RSTA in response to the IFTMR frame, the RSTA can indicate whether it will accept the CPM reporting request or not within the FTM session. This can be indicated in the CPM Request subfield of the FTM Parameters element or the Ranging Parameters element of the IFTM frame. In some variations, the CPM Request field may be carried in a carrier-phase-specific sub-element of the FTM Parameters element or the Ranging Parameters element.

FIG. 9C illustrates a CPM enabled field in the RSTA availability window element for passive TB ranging 930 according to various embodiments of the present disclosure. The embodiment of the CPM enabled field in the RSTA availability window element for passive TB ranging 930 shown in FIG. 9C is for illustration only. Other embodiments of the CPM enabled field in the RSTA availability window element for passive TB ranging 930 could be used without departing from the scope of this disclosure.

In some variations of the above described with respect to FIGS. 9a and 9B, if an ISTA has negotiated with an RSTA a Passive TB ranging session, the RSTA may include an RSTA Availability Window element of its Beacons frames, for the benefit of PSTAs to know about the parameters of the passive ranging session. Here the Availability Window Broadcast Format subfield may be set to 1. The Passive TB Ranging Parameters field of the Availability Window Information subfield of the RSTA Availability Window element included in Beacons by the RSTA for Passive ranging may have a CPM Enabled field that can be set to 1 to indicate if the passive ranging measurements in the indicated availability window will include carrier phase measurements and reporting. Otherwise, the field may be set to 0. An example illustration of this field is depicted in FIG. 9C.

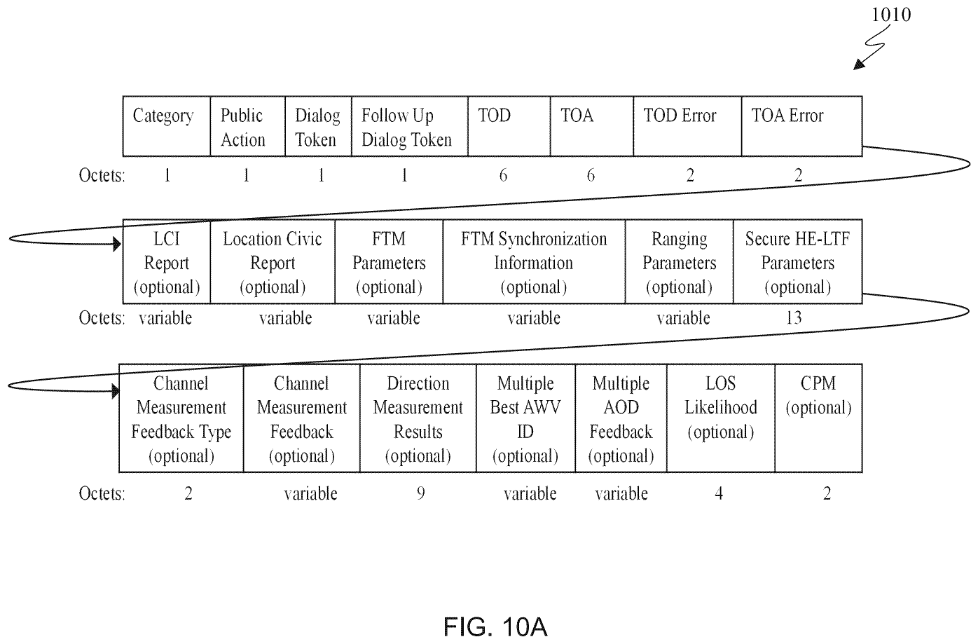

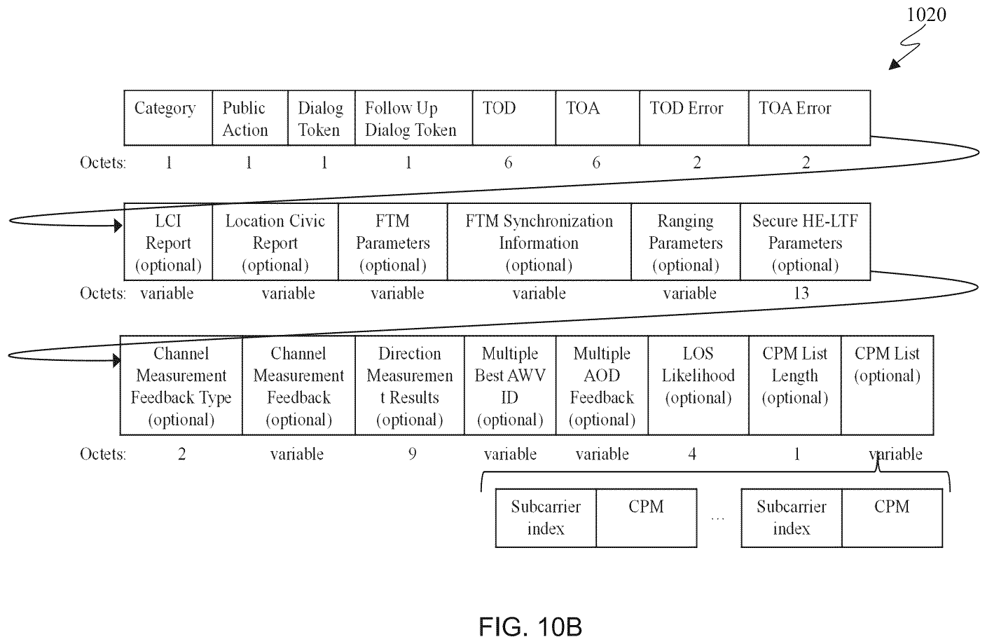

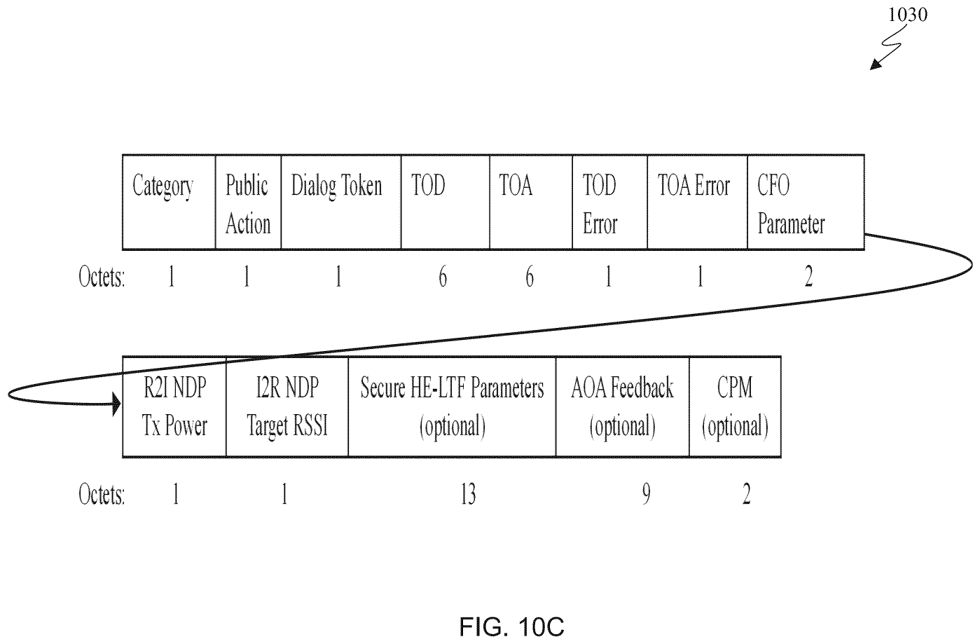

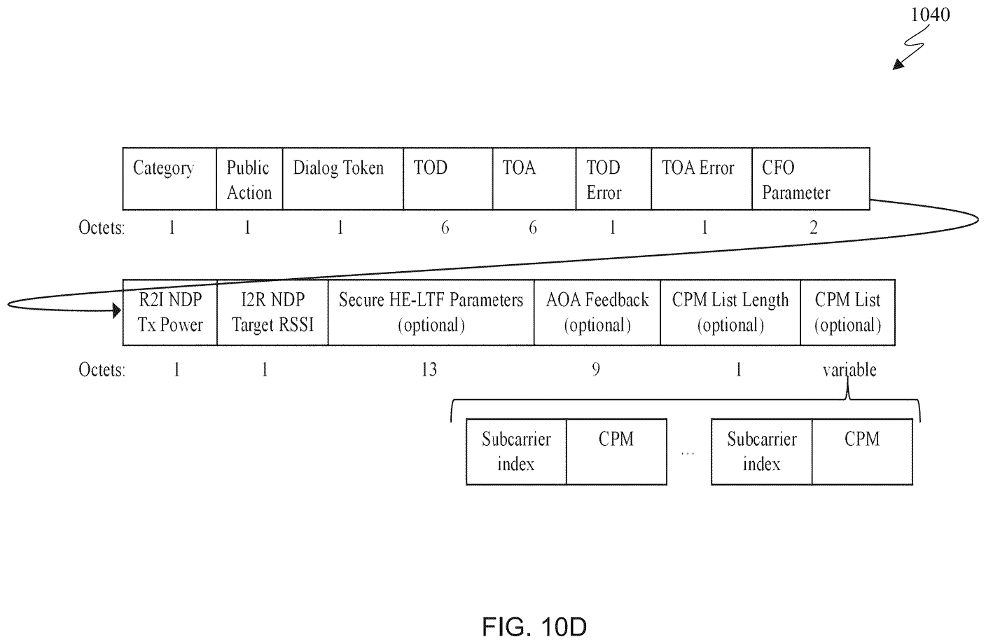

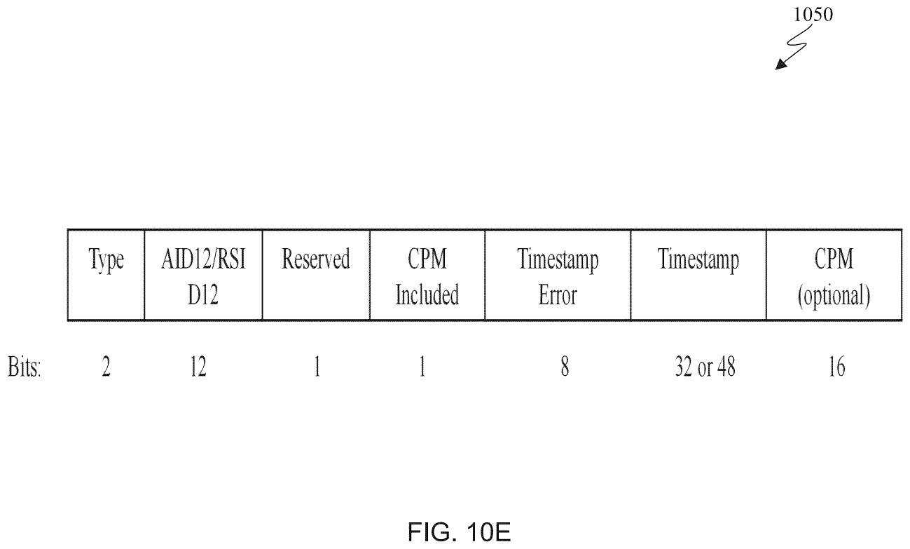

FIG. 10A illustrates CPM reporting in EDCA ranging using the FTM frame 1010 according to various embodiments of the present disclosure. The embodiment of the CPM reporting in EDCA ranging using the FTM frame 1010 shown in FIG. 10A is for illustration only. Other embodiments of the CPM reporting in EDCA ranging using the FTM frame 1010 could be used without departing from the scope of this disclosure.

FIG. 10B illustrates the multiple CPM values reporting in EDCA ranging using the FTM frame 1020 according to various embodiments of the present disclosure. The embodiment of the CPM values reporting in EDCA ranging using the FTM frame 1020 shown in FIG. 10B is for illustration only. Other embodiments of the CPM values reporting in EDCA ranging using the FTM frame 1020 could be used without departing from the scope of this disclosure.

In some embodiments of EDCA ranging, the RSTA can report the value of the carrier phase measurement in the CPM field of the FTM frame, as illustrated in FIG. 10A. In some embodiments, the CPM field may always be present, and its value may be reserved if the CPM reporting is optional and has not been negotiated between the ISTA and RSTA. In some embodiments, the CPM field is optionally present in the FTM frame only when a negotiation for CPM reporting has been made between the ISTA and RSTA. As with EDCA ranging, the value of the CPM may correspond to the value measured in the previous FTM frame exchange, as indicated in the Follow-Up Dialog Token field of the FTM frame. In one example, the CPM field can be of 9 bits, and it can report the carrier phase value measured (in degrees) from [0 to 359] (with remaining values being reserved). In another example, the CPM field can be of N bits, and the carrier phase value (in radians) can be inferred as 2π×CPM×2^{-N}. In some embodiments, the encoding of the carrier phase value can be performed in one or more formats, e.g., in positive integers or in 2's complement format, etc., and the indication of which format is used for the CPM field also be provided in a separate CPM Format field of the FTM frame. In some embodiments, along with the CPM value an indication of the sub-carrier index corresponding to the CPM measurement can also be reported in the FTM frame. In some embodiments, if the Format And Bandwidth subfield of the FTM Parameters element included in IFTM/IFTMR frames that negotiated the FTM session indicates presence of two separate local oscillators, there can be two CPM fields in the FTM frames corresponding to that FTM session, one for each oscillator. In some embodiments, the FTM frame can have a CPM List field, within which multiple CPM values can be reported along with an indication of the sub-carrier indices where they are measured, and there can be a CPM List Length field indicating the number of such reported measurements in the FTM frame. This is depicted in FIG. 10B.

FIG. 10C illustrates CPM reporting in TB and non-TB ranging using the LMR frame 1030 according to various embodiments of the present disclosure. The embodiment of the CPM reporting in TB and non-TB ranging using the LMR frame 1030 shown in FIG. 10C is for illustration only. Other embodiments of the CPM values reporting in EDCA ranging using the FTM frame 1030 could be used without departing from the scope of this disclosure.

FIG. 10D illustrates the multiple CPM reporting in TB and non-TB using the LMR frame 1040 according to various embodiments of the present disclosure. The embodiment of the multiple CPM reporting in TB and non-TB using the LMR frame 1040 shown in FIG. 10D is for illustration only. Other embodiments of the multiple CPM reporting in TB and non-TB using the LMR frame 1040 could be used without departing from the scope of this disclosure.

In some embodiments of TB ranging, the RSTA can report to an ISTA the value of the carrier phase measurement (made from the I2R NDP frame from that ISTA) in the CPM field of the Location Measurement Report (LMR) frame, as illustrated in FIG. 10C. The Dialog Token field of the LMR frame identifies the Measurement sounding phase corresponding to the I2R NDP frame from which the CPM was measured. In one example, the CPM field can be of 9 bits, and it can report the carrier phase value measured in degrees from [0 to 359] (with remaining values being reserved). In another example, the CPM field can be of N bits, and the carrier phase value can be inferred as 2π×CPM×2^{-N}. In some embodiments, the encoding of the carrier phase value can be performed in one or more formats, e.g., in positive integers or in 2's complement format, etc., and the indication of which format is used for the CPM field also be provided in a separate CPM Format field of the LMR frame. In some embodiments, along with the CPM value an indication of the sub-carrier index corresponding to the CPM measurement can also be reported in the LMR frame. In some embodiments, if the Format And Bandwidth subfield of the Ranging Parameters element included in IFTM/IFTMR frames that negotiated the FTM session indicates presence of two separate local oscillators, there can be two CPM fields in the LMR frames sent to the ISTA, one for each oscillator. In some embodiments, the LMR frame can have a CPM List field, within which multiple CPM values can be reported along with an indication of the sub-carrier indices where they are measured, and there can be a CPM List Length field indicating the number of such reported measurements in the LMR frame. This is depicted in FIG. 10D. In some embodiments, if I2R Reporting is negotiated, the ISTA may also report the CPM it measured from the R2I NDP frame in the CPM field of the LMR frame it transmits during the measurement reporting phase. Note that even if the resource units (RUs) allocated to a STA in the R2I NDP do not include the 0 subcarrier or its neighbors, the LTF is still transmitted on those sub-carriers and thus can still be used to obtain the carrier phase estimate. In one variant of this embodiment, when transmitting the I2R NDP frames if the ISTA performs CFO pre-compensation, it may ensure that the phase of pre-compensation term is ≈0 at the beginning of the LTF symbol of the I2R NDP frame, to ensure the CPM estimate is not impacted.

In some embodiments of non-TB ranging, the RSTA can report to an ISTA the value of the carrier phase measurement (made from the I2R NDP frame from that ISTA) in the CPM field of the Location Measurement Report (LMR) frame, as illustrated in FIG. 10C. The Dialog Token field of the LMR frame identifies the Measurement sounding phase corresponding to the I2R NDP frame from which the CPM was measured. In one example, the CPM field can be of 9 bits, and it can report the carrier phase value measured in degrees from [0 to 359] (with remaining values being reserved). In another example, the CPM field can be of N bits, and the carrier phase value can be inferred as 2π×CPM×2^{-N}. In some embodiments, the encoding of the carrier phase value can be performed in one or more formats, e.g., in positive integers or in 2's complement format, etc., and the indication of which format is used for the CPM field also be provided in a separate CPM Format field of the LMR frame. In some embodiments, along with the CPM value an indication of the sub-carrier index corresponding to the CPM measurement can also be reported in the LMR frame. In some embodiments, if the Format And Bandwidth subfield of the Ranging Parameters element included in IFTM/IFTMR frames that negotiated the FTM session indicates presence of two separate local oscillators, there can be two CPM fields in the LMR frames sent to the ISTA, one for each oscillator. In some embodiments, the LMR frame can have a CPM List field, within which multiple CPM values can be reported along with an indication of the sub-carrier indices where they are measured, and there can be a CPM List Length field indicating the number of such reported measurements in the LMR frame. This is depicted in FIG. 10D. In some embodiments, if I2R Reporting is negotiated, the ISTA may also report the CPM it measured from the R2I NDP frame in the CPM field of the LMR frame it transmits during the measurement reporting phase.

FIG. 10E illustrates the timestamp measurement report subfield of RSTA/ISTA passive TB ranging measurement report frame 1050 according to various embodiments of the present disclosure. The embodiment of the timestamp measurement report subfield of RSTA/ISTA passive TB ranging measurement report frame 1050 shown in FIG. 10E is for illustration only. Other embodiments of the timestamp measurement report subfield of RSTA/ISTA passive TB ranging measurement report frame 1050 could be used without departing from the scope of this disclosure.

In some embodiments of passive TB ranging, the RSTA can report to one or more ISTAs the values of the carrier phase measurements (made from the I2R NDP frames from that ISTAs) in the Timestamp Measurement Report subfield of the RSTA Passive TB Ranging Measurement Report frame. Similarly, in some embodiments of passive TB ranging, the ISTA can report to the RSTA the values of the carrier phase measurements (made from the R2I NDP frame and optionally from I2R NDPs of other ISTAs) in the Timestamp Measurement Report subfields of the ISTA Passive TB Ranging Measurement Report frame. The AID12/RSID12 subfield of the Timestamp Measurement Report identifies the transmitting STA from which the measurement is made. Additionally, there can be a 1-bit CPM Included field in the Timestamp Measurement Report to indicate if the carrier phase measurement is reported in the Timestamp Measurement Report. When CPM Included field is set to 1, an optional CPM field can be present as illustrated in FIG. 10E. If the Type subfield is set to 00, the CPM Included subfield may be set to 0. In one example, the CPM field can be of 9 bits, and it can report the carrier phase value measured in degrees from [0 to 359] (with remaining values being reserved). In another example, the CPM field can be of N bits, and the carrier phase value can be inferred as 2π×CPM×2^{-N}. In some embodiments, the CPM field can be encoded using one of several formats, and the format used can be indicated in a CPM Format field of the Timestamp Measurement Report. In some embodiments, along with the CPM value an indication of the sub-carrier index corresponding to the CPM measurement can also be reported in the Timestamp Measurement Report. In some embodiments, if the Format And Bandwidth subfield of the Ranging Parameters element included in IFTM/IFTMR frames that negotiated the FTM session indicates presence of two separate local oscillators, there can be two CPM fields in the Timestamp Measurement Reports, one for each oscillator. In some embodiments, the Timestamp Measurement Report can have a CPM List field, within which multiple CPM values can be reported along with an indication of the sub-carrier indices where they are measured.

In some embodiments of passive TB ranging, the RSTA can broadcast the values of the carrier phase measurements (made from the I2R NDP frames from one or more ISTAs) in the RSTA Passive TB Ranging Measurement report subfield of the Primary RSTA Broadcast Passive TB Ranging Measurement Report that it transmits. Similarly, the RSTA can broadcast the values of the carrier phase measurements reported by one or more ISTAs in the ISTA Passive TB Ranging Measurement Report subfield of the Secondary RSTA Broadcast Passive TB Ranging Measurement Report that it transmits. The encoding of the carrier phase measurement can be as in FIG. 10E.

In some embodiments, the IRSTA can request the RSTA to report the LoS assessment in EDCA, TB and/or non-TB ranging. Such an inference can be made by RSTA, for example, by observing the fraction of the channel power concentrated in the largest delay bin of the channel impulse response (obtained by taking a Fourier transform of the channel estimates ĥ_{b,i,k}⁽¹⁾ across the sub-carriers k). The result of the inference can be included in the LOS Likelihood field of the FTM frame or the LMR frame transmitted by the RSTA. The ability to provide such an inference can be provided in a LOS Assessment field of a Capabilities element (similar to embodiment 1).

In some embodiments, the ISTA can request the RSTA to report the carrier frequency offset (CFO) value measured by it in the frame exchanges of the EDCA, TB and/or non-TB ranging. In the case of EDCA ranging, the RSTA can measure this from the ACK frames sent by the ISTA. In the case of TB ranging and non-TB ranging, the RSTA can measure these values from the I2R NDP frames transmitted by the ISTA. The estimated CFO value can be included in the CFO Parameter field of the FTM frame or the LMR frame transmitted by the RSTA. The value of the CFO Parameter field can indicate the clock rate difference between the ISTA and RSTA in units of 0.01 parts per million. The capability to provide the CFO value can be provided in a CFO Feedback Support field of a Capabilities element (similar to embodiment 1).

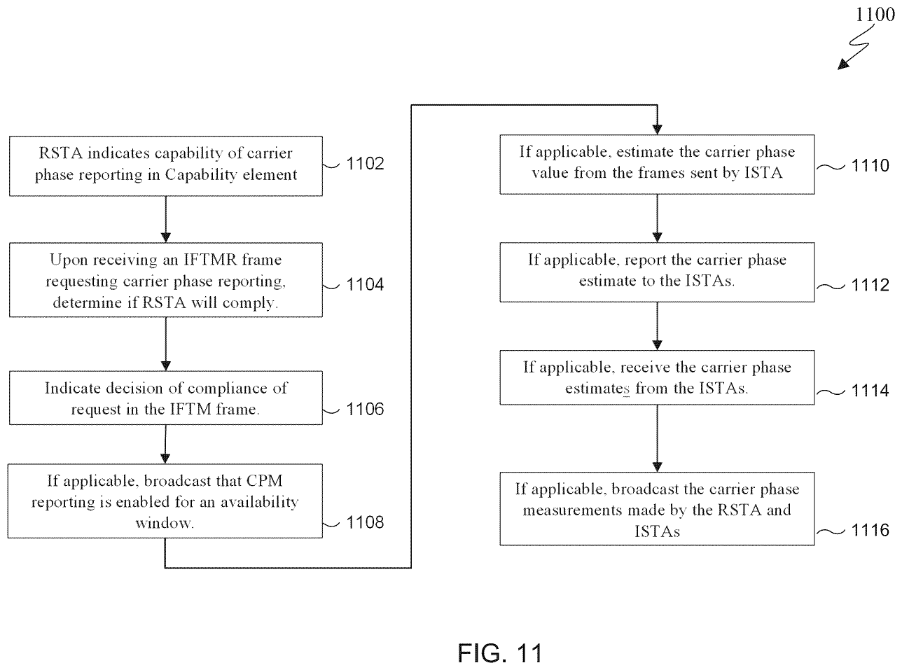

FIG. 11 illustrates a flow diagram of a method 1100 performed by an RSTA for enabling carrier phase measurement and reporting in FTM according to various embodiments of the present disclosure. The embodiment of the method 1100 performed by an RSTA for enabling carrier phase measurement and reporting in FTM shown in FIG. 11 is for illustration only. Other embodiments of the method 1100 performed by an RSTA for enabling carrier phase measurement and reporting in FTM could be used without departing from the scope of this disclosure.

As illustrated in FIG. 11, the method 1100 begins at step 1102, where the RSTA indicates capability of carrier-phase reporting in the capability element. At step 1104, upon receiving an IFTMR frame requesting carrier phase reporting, a determination is made whether the RSTA will comply. At step 1106, the RSTA indicates a decision of compliance of regarding the request for carrier phase reporting in the IFTM frame. At step 1108, the RSTA broadcasts that CPM reporting is enabled for an availability window. At step 1110, the carrier phase value from the frame sent by the ISTA is estimated. At step 1112, the carrier phase estimate is reported to the ISTAs. At step 1114, the carrier phase estimates are received from the ISTAs. At step 1116, the carrier phase measurements made by the RSTA and the ISTA are broadcast.

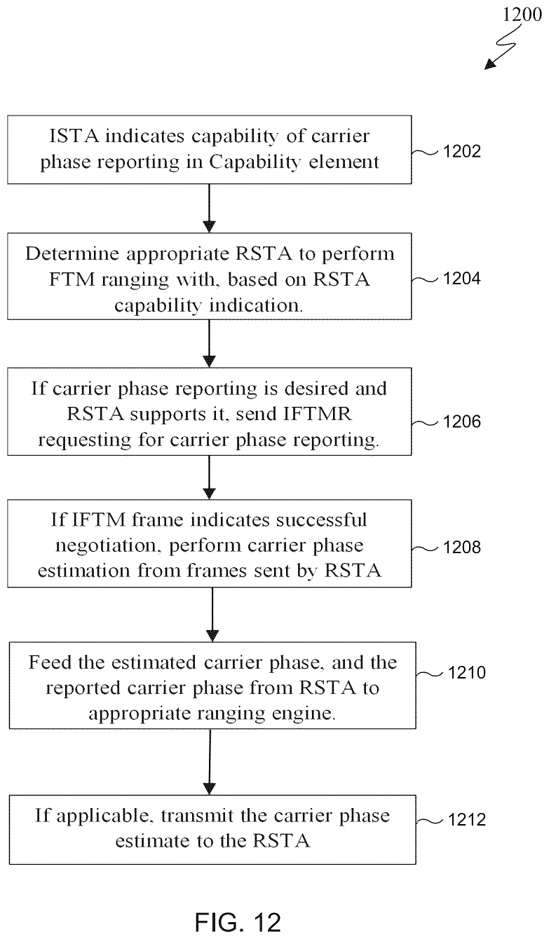

FIG. 12 illustrates a flow diagram of a method 1200 performed by an ISTA for enabling carrier phase measurement and reporting in FTM according to various embodiments of the present disclosure. The embodiment of the method 1200 performed by an ISTA for enabling carrier phase measurement and reporting in FTM shown in FIG. 12 is for illustration only. Other embodiments of the method 1200 performed by an ISTA for enabling carrier phase measurement and reporting in FTM could be used without departing from the scope of this disclosure.

As illustrated in FIG. 12, the method 1200 begins at step 1202, where the ISTA indicates capability of carrier phase reporting in the capability element. At step 1204, the ISTA determines the appropriate RSTA to perform FTM ranging with based on the RSTA capability information. At step 1206, if carrier phase reporting is desired, the ISTA sends an IFTMR requesting for carrier phase reporting. At step 1208, if the IFTM frame indicates successful negotiation, the ISTA performs carrier phase estimation from the frames sent by the RSTA. At step 1210, the ISTA sends the estimated carrier phase, and the reported carrier phase from the RSTA to the appropriate ranging engine. At step 1212, the ISTA transmits the carrier phase estimate to the RSTA.

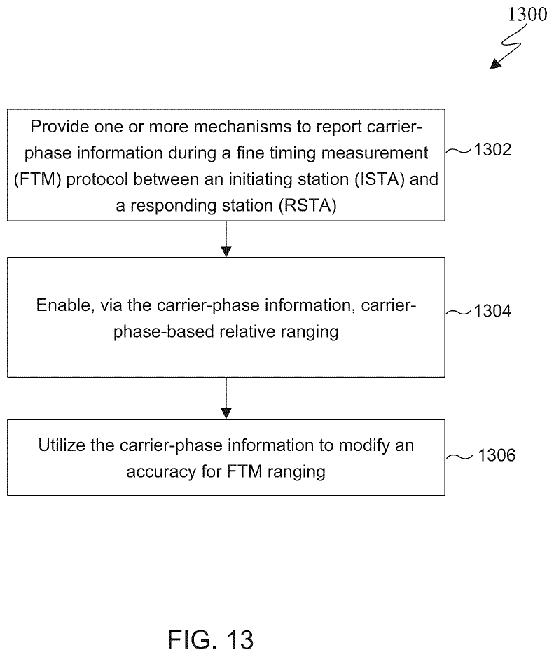

FIG. 13 illustrates a flow diagram of a method 1300 for wireless communication performed by a station device according to embodiments of the present disclosure. The example method 1300 shown in FIG. 13 is for illustration only. Other embodiments of the example method 1300 could be used without departing from the scope of this disclosure.

As illustrated in FIG. 13, the method 1300 begins at step 1302, where the STA provides one or more mechanisms to report carrier-phase information during a fine timing measurement (FTM) protocol between the ISTA and a responding station (RSTA). At step 1304, the STA enables, via the carrier-phase information, carrier-phase-based relative ranging. At step 1306, the STA utilizes the carrier-phase information to modify an accuracy for FTM ranging.

In one embodiment, the STA indicates a capability for reporting carrier phase measurements (CPM), and receives an indication from the RSTA of the capability of reporting CPM in at least some FTM ranging protocols.

In one embodiment, the STA requests a carrier phase measurements (CPM) reporting from the RSTA when initiating an FTM ranging session corresponding to at least some FTM ranging protocols.

In one embodiment, the STA receives an indication from the RSTA that carrier phase measurements (CPM) are included from the RSTA during an FTM measurement reporting phase of an FTM session.

In one embodiment, the STA receives a report of one or more CPM values, the report including one or more of: one or more CPM values, subcarrier indices corresponding to the one or more CPM values, link identifiers corresponding to the one or more CPM values, and an index of an FTM frame corresponding to the one or more CPM values.

In one embodiment, the STA performs carrier phase estimation based on the received CPM to produce a carrier phase estimate; and transmits the carrier phase estimate to the RSTA.

In one embodiment, the STA receives reporting of carrier phase measurements (CPM) from the RSTA during an FTM measurement reporting phase of an FTM session.

In one embodiment, the STA requests carrier frequency offset (CFO) and Line-of-Sight (LoS) assessment reporting from the RSTA during the FTM measurement reporting phase of an FTM session.

In one embodiment, the STA reports carrier phase measurements (CPM) during an FTM measurement reporting phase of an FTM session.

In one embodiment, the STA receives an indication from the RSTA that carrier phase measurements (CPM) reporting is enabled during an availability window.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by an initiating station (ISTA), the method comprising:
providing one or more mechanisms to report carrier-phase information during a fine timing measurement (FTM) protocol between the ISTA and a responding station (RSTA);
enabling, via the carrier-phase information, carrier-phase-based relative ranging; and
utilizing the carrier-phase information to modify an accuracy for FTM ranging.

2. The method of claim 1, further comprising indicating a capability for reporting carrier phase measurements (CPM), and receiving an indication from the RSTA of the capability of reporting CPM in at least some FTM ranging protocols.

3. The method of claim 1, further comprising requesting a carrier phase measurements (CPM) reporting from the RSTA when initiating an FTM ranging session corresponding to at least some FTM ranging protocols.

4. The method of claim 1, further comprising receiving an indication from the RSTA that carrier phase measurements (CPM) are included from the RSTA during an FTM measurement reporting phase of an FTM session.

5. The method of claim 1, further comprising receiving a report of one or more CPM values, the report including one or more of: one or more CPM values, subcarrier indices corresponding to the one or more CPM values, link identifiers corresponding to the one or more CPM values, and an index of an FTM frame corresponding to the one or more CPM values.

6. The method of claim 4, further comprising:
performing carrier phase estimation based on the received CPM to produce a carrier phase estimate; and
transmitting the carrier phase estimate to the RSTA.

7. The method of claim 1, further comprising receiving reporting of carrier phase measurements (CPM) from the RSTA during an FTM measurement reporting phase of an FTM session.

8. The method of claim 1, further comprising requesting carrier frequency offset (CFO) and Line-of-Sight (LoS) assessment reporting from the RSTA during the FTM measurement reporting phase of an FTM session.

9. The method of claim 1, further comprising reporting carrier phase measurements (CPM) during an FTM measurement reporting phase of an FTM session.

10. The method of claim 1, further comprising receiving an indication from the RSTA that carrier phase measurements (CPM) reporting is enabled during an availability window.

11. An initiating station (ISTA), comprising:
a transceiver; and
a processor operably coupled to the transceiver, the processor configured to:
provide one or more mechanisms to report carrier-phase information during a fine timing measurement (FTM) protocol between the ISTA and a responding station (RSTA);
enable, via the carrier-phase information, carrier-phase-based relative ranging; and
utilize the carrier-phase information to modify an accuracy for FTM ranging.

12. The ISTA of claim 11, wherein the processor is further configured to:
indicate a capability for reporting carrier phase measurements (CPM); and
receive, via the transceiver, an indication from the RSTA of the capability of reporting CPM in at least some FTM ranging protocols.

13. The ISTA of claim 11, wherein the processor is further configured, via the transceiver, to request a carrier phase measurements (CPM) reporting from the RSTA when initiating an FTM ranging session corresponding to at least some FTM ranging protocols.

14. The ISTA of claim 11, wherein the processor is further configured, via the transceiver, to receive an indication from the RSTA that carrier phase measurements (CPM) are included from the RSTA during an FTM measurement reporting phase of an FTM session.

15. The ISTA of claim 11, wherein the processor is further configured, via the transceiver, to receive a report of one or more CPM values, the report including one or more of: one or more CPM values, subcarrier indices corresponding to the one or more CPM values, link identifiers corresponding to the one or more CPM values, and an index of an FTM frame corresponding to the one or more CPM values.

16. The ISTA of claim 14, wherein:
the processor is further configured to perform carrier phase estimation based on the received CPM to produce a carrier phase estimate; and
the transceiver is further configured to transmit the carrier phase estimate to the RSTA.

17. The ISTA of claim 11, wherein the processor is further configured, via the transceiver, to receive reporting of carrier phase measurements (CPM) from the RSTA during an FTM measurement reporting phase of an FTM session.

18. The ISTA of claim 11, wherein the processor is further configured, via the transceiver, to request carrier frequency offset (CFO) and Line-of-Sight (LoS) assessment reporting from the RSTA during the FTM measurement reporting phase of an FTM session.

19. The ISTA of claim 11, wherein the processor is further configured, via the transceiver, to report carrier phase measurements (CPM) during an FTM measurement reporting phase of an FTM session.

20. The ISTA of claim 11, wherein the processor is further configured, via the transceiver, to receive an indication from the RSTA that carrier phase measurements (CPM) reporting is enabled during an availability window.
